(19) United States
(12) Patent Application Publication
(10) Pub. No.: US 2026/0163463 A1
(43) Pub. Date: Jun. 11, 2026

(54) Load Line Control Apparatus and Method

(71) Applicant: Reed Semiconductor Corporation, Warwick, RI (US)

(72) Inventors: Biranchinath Sahu, Bangalore (IN); Naga Venkata Prasadu Mangina, Bengaluru (IN); Rajeev Singla, Punjab (IN); Ashwani Kumar Singh, Bengaluru (IN)

(21) Appl. No.: 18/976,222

(22) Filed: Dec. 10, 2024

(51) Int. Cl. H02M 1/00; H02M 1/14; H02M 3/155

(52) U.S. Cl. CPC H02M 1/0043; H02M 1/14; H02M 3/155

(57) ABSTRACT

An apparatus includes a first control path configured to provide a dc load line setting, and a second control path configured to provide an ac load line setting, wherein the dc load line setting is configured to determine a load and output voltage relationship during steady state operating conditions, the ac load line setting is configured to provide a fast transient response during transient operating conditions, and the first control path is independent from the second control path.

### TECHNICAL FIELD

The present disclosure relates generally to the field of multiphase power conversion systems, and in particular embodiments, to a load line control apparatus in a multiphase controller.

### BACKGROUND

As technologies further advance, a variety of processors such as Digital Signal Processors (DSPs), Field Programmable Gate Arrays (FPGAs), Central Processing Units (CPUs) and/or the like, have become popular. Each processor operates with a low supply voltage (e.g., sub-1V) and consumes a large amount of current. A multiphase power conversion system is employed to power the processor. The multiphase power conversion system comprises a multiphase controller and a plurality of power stages.

The multiphase controller is an integrated circuit designed to manage and regulate power delivery in the multiphase power conversion system. This type of controller is commonly used in power supplies for processors consuming a large amount of current. The multiphase controller is configured to control plurality of power stages by generating multiple Pulse Width Modulation (PWM) signals and monitoring current sense signals. The primary objective is to distribute the load across several phases, enhancing power delivery efficiency, reducing ripple, and improving overall performance.

The core of the multiphase controller is a PWM controller. In operation, the PWM controller generates precise PWM signals for each power stage. These signals are used to control the switching of power switches in each phase, regulating the voltage and current supplied to the load. The PWM signals are typically phase-shifted to interleave the switching of each power stage. This reduces the input and output ripple currents, thereby improving the overall efficiency and reducing the size of filtering components.

Load line control in power converters refers to a technique used to regulate the output voltage and current by adjusting the characteristics of the output to suit the load requirements. In essence, it involves managing the relationship between the output voltage and the load current so as to optimize performance, efficiency, and stability.

In load line control, it includes a dc path and an ac path. Both paths are essential components that help in managing the output voltage and current relationship under different loading conditions. The dc path primarily deals with the steady-state behavior of the output of the multiphase power conversion system. It sets the target operating point on the load line under stable conditions, determining how the output voltage changes in response to changes in the average load current. The ac path is designed to respond to transient changes in load current, such as when a processor or other load shifts quickly from low to high power demand. The ac path provides rapid adjustment to maintain stable operation during these fast transitions.

A digital-to-analog converter (DAC) based circuit can be used to modulate the output voltage during load line control, especially in advanced power converters, to dynamically adjust the output voltage in response to varying load currents. This type of design is often employed in high-performance systems like CPUs, GPUs, or other electronic devices that require precise voltage regulation under fluctuating load conditions. In operation, The DAC receives digital signals from a controller, such as a microcontroller, DSP, or FPGA. The digital signals represent the desired adjustments to the output voltage. These digital signals are based on real-time monitoring of the load current or system requirements. For example, if the load current increases, the DAC can reduce the reference voltage to allow a controlled droop in the output voltage. The DAC then converts these digital signals into a corresponding analog control voltage. This analog voltage can be used to modulate or adjust the reference voltage of the power converter, which in turn controls the output voltage.

In a conventional load line control apparatus, the dc and ac paths are intertwined, preventing independent adjustment of key parameters. Specifically, the dc path comprises a circuit to adjust the integrator's time constant, while the ac path comprises a circuit to control the ac gain. However, these two paths lack independence, making it impossible to separately tune the ac gain and the time constant. This disclosure presents a solution to decouple the ac and dc paths, enabling independent control over both the ac gain and the integrator time constant.

### SUMMARY

Technical advantages are generally achieved, by embodiments of this disclosure which describe a load line control apparatus in a multiphase controller.

In accordance with one aspect of the present disclosure, an apparatus comprises a first control path configured to provide a dc load line setting, and a second control path configured to provide an ac load line setting, wherein the dc load line setting is configured to determine a load and output voltage relationship during steady state operating conditions, the ac load line setting is configured to provide a fast transient response during transient operating conditions, and the first control path is independent from the second control path.

In accordance with another aspect of the present disclosure, a method comprises configuring a plurality of power stages to provide power to a load, wherein the plurality of power stages is connected in parallel between an input voltage bus and an output voltage bus, configuring a first control path to provide a dc load line setting for the plurality of power stages, dc wherein the dc load line setting is configured to determine a load and output voltage relationship during steady state operating conditions, and configuring a second control path to provide an ac load line setting for the plurality of power stages, wherein the ac load line setting is configured to provide a fast transient response during transient operating conditions.

In accordance with another aspect of the present disclosure, a power conversion system comprises a plurality of power stages connected in parallel between an input voltage bus and an output voltage bus, and a controller comprising a first control path configured to provide a dc load line setting and a second control path configured to provide an ac load line setting, wherein the dc load line setting is configured to determine a load and output voltage relationship during steady state operating conditions, the ac load line setting is configured to provide a fast transient response during transient operating conditions, and the first control path is independent from the second control path.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram of a power conversion system in accordance with various embodiments of the present disclosure;

FIG. 2 illustrates a schematic diagram of the smart power stage shown in FIG. 1 in accordance with various embodiments of the present disclosure;

FIG. 3 illustrates a block diagram of a load line control apparatus in accordance with various embodiments of the present disclosure;

FIG. 4 illustrates a schematic diagram of the dc control path of the load line control apparatus in accordance with various embodiments of the present disclosure;

FIG. 5 illustrates a schematic diagram of the ac control path of the load line control apparatus in accordance with various embodiments of the present disclosure;

FIG. 6 illustrates a schematic diagram of the first summing circuit shown in FIG. 3 in accordance with various embodiments of the present disclosure;

FIG. 7 illustrates a schematic diagram of the second summing circuit shown in FIG. 3 in accordance with various embodiments of the present disclosure;

FIG. 8 illustrates a schematic diagram of the adjustable resistors shown in FIGS. 4-5 in accordance with various embodiments of the present disclosure; and

FIG. 9 illustrates a flow chart of a method for load line control in the power conversion system shown in FIG. 1 in accordance with various embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

The present disclosure will be described with respect to embodiments in a specific context, namely a load line control apparatus in a multiphase power conversion system. The disclosure may also be applied, however, to a variety of power conversions systems. Hereinafter, various embodiments will be explained in detail with reference to the accompanying drawings.

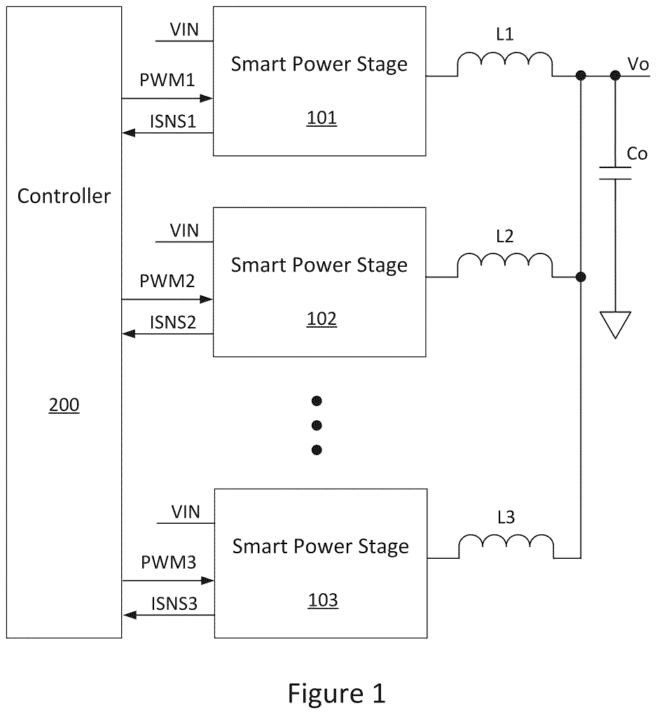

FIG. 1 illustrates a block diagram of a power conversion system in accordance with various embodiments of the present disclosure. The power conversion system comprises a multiphase controller 200, a plurality of smart power stages 101, 102 and 103, a plurality of inductors L1, L2 and L3, and an output capacitor Co. As shown in FIG. 1, each of the plurality of smart power stages (e.g., smart power stage 101) and a corresponding inductor (e.g., L1) are connected in series to form a power conversion stage. In some embodiments, the power conversion stage is a step-down power conversion stage. The plurality of smart power stages 101, 102 and 103, and the plurality of inductors L1, L2 and L3 form a plurality of step-down power conversion stages connected in parallel between an input voltage bus VIN and an output voltage bus Vo. A load (not shown) is coupled to the output voltage bus Vo. In some embodiments, the load may be a processor (e.g., a central processing unit).

The multiphase controller 200 is connected to the plurality of smart power stages 101, 102 and 103. The multiphase controller 200 feeds a PWM signal PWM1 to a first smart power stage 101. The multiphase controller 100 feeds a PWM signal PWM2 to a second smart power stage 102. The multiphase controller 100 feeds a PWM signal PWM3 to a third smart power stage 103. As shown in FIG. 1, the multiphase controller 200 receives a first current sense signal ISNS1 from the first smart power stage 101. The multiphase controller 200 receives a second current sense signal ISNS2 from the second smart power stage 102. The multiphase controller 200 receives a third current sense signal ISNS3 from the third smart power stage 103.

The multiphase controller 200 acts as a central control unit that coordinate the operation of all smart power stages. The multiphase controller 200 generates PWM signals, which are essential for controlling the output voltage and current of each smart power stage. The PWM signals are precisely timed and modulated to manage power delivery efficiently. The multiphase controller 200 receives current sense signals from smart power stages. These current sense signals provide feedback about the current being delivered by each phase, allowing the multiphase controller 200 to monitor and adjust the operation of the smart power stages.

Each smart power stage represents an individual phase of the multiphase power conversion system. They are independently controlled by the PWM signals sent from the multiphase controller 200. Each smart power stage includes current sensing mechanisms to measure the current flowing through it. The sensed current data is then sent back to the multiphase controller 200. The current sense signals are used by the multiphase controller 200 to adjust the PWM signals dynamically, ensuring power delivery and load balancing across all phases.

In operation, the multiphase controller 200 calculates the required PWM signals based on the desired output and the feedback received from the smart power stages. The multiphase controller 200 sends out these PWM signals to the respective smart power stages, controlling their operation in a synchronized manner. Each smart power stage senses the current flowing through it and sends this data back to the multiphase controller 200. The multiphase controller 200 processes this current sense information to determine the load distribution and current levels in each phase. Based on the feedback, the multiphase controller 200 dynamically adjusts the PWM signals fed into the smart power stages. This adjustment helps in balancing the load, preventing any single phase from becoming overloaded, and maintaining the overall efficiency and stability of the multiphase power conversion system.

In some embodiments, the multiphase controller 200 may be a system controller or a system control apparatus. The multiphase controller 200 may be implemented as a microprocessor, a digital signal processor and the like.

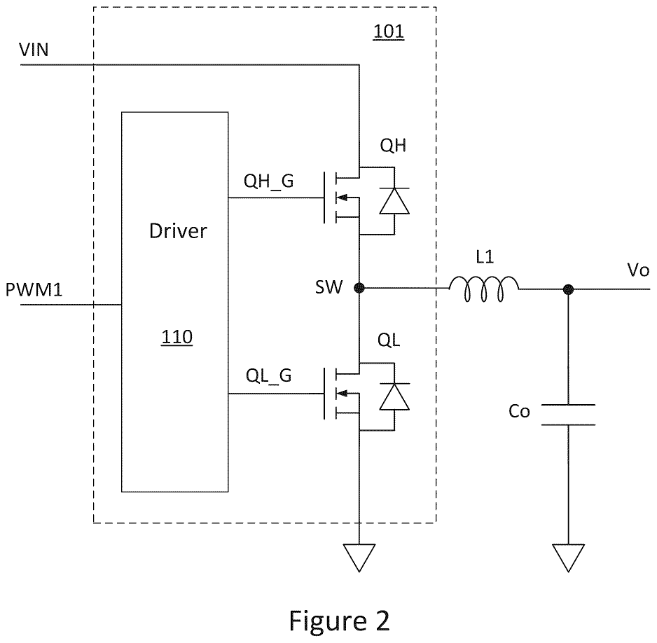

In some embodiments, the power conversion stage (e.g., power conversion stage formed by the smart power stage 101 and the inductor L1) is implemented as a step-down power converter. In some embodiments, the smart power stage comprises both high-side and low-side power switches responsible for regulating the output voltage of the step-down power converter. The smart power stage also includes the gate driver circuitry that controls the high-side and low-side power switches, optimizing the switching operation for speed and efficiency. The smart power stage may further comprise other key components such as current sensing, temperature sensing, overcurrent protection, overvoltage protection, under-voltage protection and various digital communication interfaces. The detailed structure of the smart power stage will be described below with respect to FIG. 2. Alternatively, the power conversion stage may be implemented as any suitable power converters such as an inductor-inductor-capacitor (LLC) converter, a switched capacitor converter, a hybrid switched capacitor converter, a full bridge power converter, a half bridge power converter, a buck converter, any combinations thereof and the like.

It should be noted that FIG. 1 illustrates only three smart power stages of a multiphase power conversion system that may include a plurality of such smart power stages (e.g., N smart power stages). The number of smart power stages illustrated herein is limited solely for the purpose of clearly illustrating the inventive aspects of the various embodiments. The present disclosure is not limited to any specific number of smart power stages.

FIG. 2 illustrates a schematic diagram of the smart power stage shown in FIG. 1 in accordance with various embodiments of the present disclosure. The smart power stage 101 comprises a high-side switch QH, a low-side switch QL and a driver 110. As shown in FIG. 2, the high-side switch QH and the low-side switch QL are connected in series between the input voltage bus VIN and ground. An output inductor L1 is connected between a common node (SW) of the high-side switch QH and the low-side switch QL, and the output voltage bus Vo. The output capacitor Co is connected between the output voltage bus Vo and ground. The driver 110 is configured to receive a PWM signal PWM1 from the multiphase controller 200. Based on the received signal, the driver 110 generates gate drive signals QH_G and QL_G for the high-side switch QH and the low-side switch QL, respectively. In some embodiments, the high-side switch QH, the low-side switch QL and the driver 110 are in a smart power stage semiconductor package.

In operation, when the high-side switch QH is turned on, and the low-side switch QL is turned off, a current flows from the input voltage VIN to the load through the output inductor L1. The output inductor L1 opposes sudden changes in current by storing energy in its magnetic field. The output capacitor Co supplies the load with current, smoothing out the output voltage Vo. When the high-side switch QH is turned off, and the low-side switch QL is turned on, the output inductor L1 releases its stored energy to maintain the current flow to the load. The output capacitor Co continues to smooth the output voltage. In operation, the duty cycle (the ratio of the turn-on time of the high-side switch QH to the total switching period) is used to control the output voltage Vo. By adjusting the duty cycle, the output voltage Vo can be regulated at a predetermined level.

In accordance with an embodiment, the switches (e.g., switches QH and QL) may be metal oxide semiconductor field-effect transistor (MOSFET) devices. Alternatively, the switches can be any controllable switches such as insulated gate bipolar transistor (IGBT) devices, integrated gate commutated thyristor (IGCT) devices, gate turn-off thyristor (GTO) devices, silicon controlled rectifier (SCR) devices, junction gate field-effect transistor (JFET) devices, MOS controlled thyristor (MCT) devices, gallium nitride (GaN)-based power devices, silicon carbide (SiC)-based power devices and the like.

It should be noted while FIG. 2 shows the switches QH and QL are implemented as single n-type transistors, a person skilled in the art would recognize there may be many variations, modifications and alternatives. For example, depending on different applications and design needs, the switches QH and QL may be implemented as p-type transistors. Furthermore, each switch shown in FIG. 2 may be implemented as a plurality of switches connected in parallel. Moreover, a capacitor may be connected in parallel with one switch to achieve zero voltage switching (ZVS)/zero current switching (ZCS).

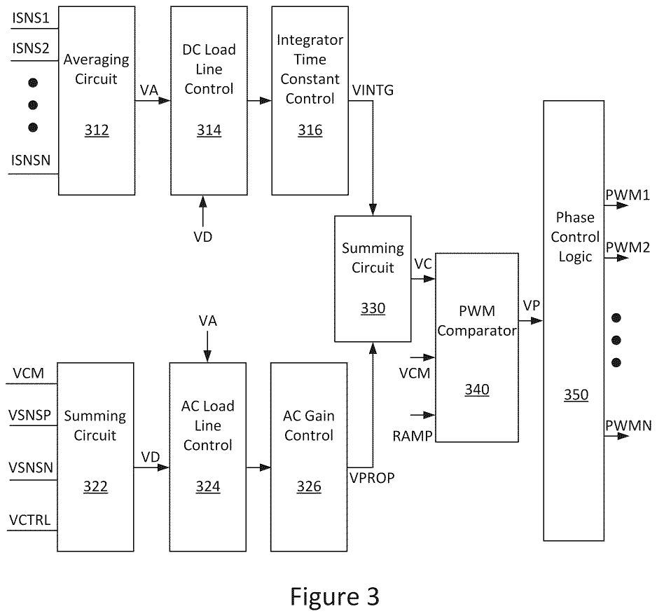

FIG. 3 illustrates a block diagram of a load line control apparatus in accordance with various embodiments of the present disclosure. The load line control apparatus comprises an averaging circuit 312, a dc load line control unit 214, an integrator time constant control unit 316, a first summing circuit 322, an ac load line control unit 324, an ac gain control unit 326 and a second summing circuit 330. The load line control apparatus is configured to receive current sensed signals ISNS1-ISNSN, a predetermined reference VCM, a positive output voltage VSNSP of the power conversion system, a negative output voltage VSNSN of the power conversion system and a load line control signal VCTRL. The load line control apparatus is configured to generate a control signal VC fed into a PWM generator 340. The PWM generator 340 is configured to receive the control signal VC, the predetermined reference VCM and a ramp signal RAMP. Based on the received signals, the PWM generator 340 is configured to generate a PWM signal VP fed into a phase control logic unit 350.

In operation, the phase control logic unit 350 is designed to generate PWM signals PWM1-PWMN across multiple phases to achieve efficient power conversion. Each phase in the converter has its own PWM signal, with these signals typically staggered in time to reduce ripple in both input and output currents. This staggering distributes the load across the phases more evenly, improves thermal performance, and enhances efficiency. By carefully controlling each PWM signal's duty cycle, the power conversion system can respond dynamically to varying load conditions, ensuring consistent power delivery with minimal losses.

In some embodiments, the dc load line control is decoupled from the ac load line control to enable improved precision and responsiveness in managing both dc and ac paths independently. As shown in FIG. 3, the load line control apparatus comprises a dc load line control path and an ac load line control path. The dc load line control path comprises the dc load line control unit 314 and the integrator time constant control unit 316 connected in cascade between the averaging circuit 312 and a first input of the second summing circuit 330. The ac load line control path comprises the ac load line control unit 324 and the ac gain control unit 326 connected in cascade between the first summing circuit 322 and a second input of the second summing circuit 330. As shown in FIG. 3, these two load line control paths are decoupled from each other. Both load line control paths are configured to receive an averaging current signal VA generated by the first averaging circuit 312 and a droop signal generated by the first summing circuit 322.

The dc load line control path is configured to provide a dc load line setting. In particular, the dc load line control path is configured to control the steady-state behavior of the power conversion system. The dc load line control path sets the target operating point on the load line under stable conditions, determining how the output voltage changes in response to changes in the average load current. In other words, the dc load line control path is configured to determine a load and output voltage relationship during steady state operating conditions.

The ac load line control path is configured to provide an ac load line setting. In particular, the ac load line control path is configured to respond to transient changes in load current. The ac load line control path provides rapid adjustments to maintain stable operation during these fast transitions.

In a conventional load line control apparatus, these two control functions are coupled. As such, adjustments to one line can inadvertently affect the performance of the other, leading to suboptimal control outcomes, such as instability, slower response, or increased power losses. By decoupling, the power conversion system can separately manage the steady-state voltage level for the dc load, optimizing it for minimal power loss, while independently controlling the ac load for dynamic performance, such as rapid response to changes in load conditions. This decoupling enhances overall system performance by allowing each control path to be finely tuned according to its specific requirements, thereby achieving improved stability, efficiency, and adaptability across a range of operating conditions.

In some embodiments, the dc load line control path is a slow control path. Throughout the description, the dc load line control path is alternatively referred to as a first control path. The ac load line control path is a fast control path. Throughout the description, the ac load line control path is alternatively referred to as a second control path.

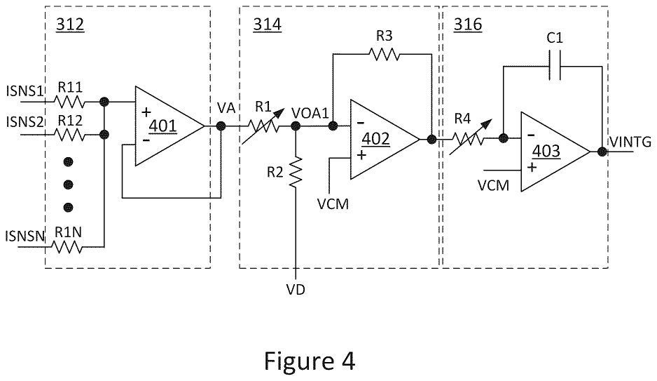

FIG. 4 illustrates a schematic diagram of the dc control path of the load line control apparatus in accordance with various embodiments of the present disclosure. The dc control path comprises the dc load line control unit 314 and the integrator time constant control unit 316 connected in cascade. The input of the dc control path is configured to receive the average current signal VA generated by the averaging circuit 312 and the droop signal VD generated by the first summing circuit 322. The dc control path is configured to generate a dc load line control signal VINTG.

The current sense signals ISNS1-ISNSN are fed into a first amplifier 401. The first amplifier 401 functions as a current averaging circuit configured to generate an average current signal VA. As shown in FIG. 4, the non-inverting input of the first amplifier 401 is configured to receive a first current sense signal ISNS1 through a first resistor R11. The non-inverting input of the first amplifier 401 is configured to receive a second current sense signal ISNS2 through a second resistor R12. The non-inverting input of the first amplifier 401 is configured to receive an Nth current sense signal ISNSN through an Nth resistor R1N. In operation, the output of the first amplifier 401 is configured to generate an average current signal.

In some embodiments, R11-R1N are 100 kiloohm resistors. However, the resistance values of R11-R1N can be adjusted based on the impedances of the ISNS1-ISNSN drive sources, the capacitance associated with the resistors (R11 to R11N), and the operating frequency of the signal path.

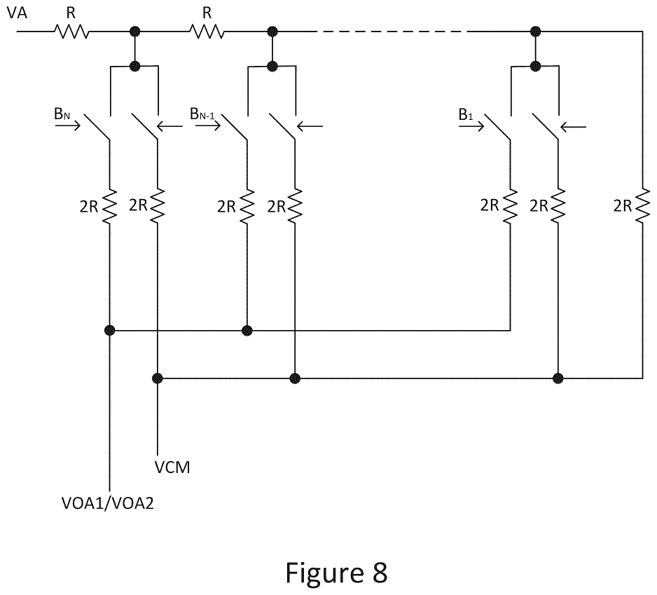

As shown in FIG. 4, the dc load line control unit 314 comprises a first resistor R1, a second resistor R2, a third resistor R3 and a second amplifier 402. The first resistor R1 and the second resistor R2 are connected in series between a first node and a second node. As shown in FIG. 4, the average current signal VA is tapped at the first node. The droop signal VD is tapped at the second node. As indicated by the arrow placed on the symbol of R1, the first resistor R1 is an adjustable resistor controlled by a dc load line control signal. In some embodiments, the first resistor R1 is implemented as an 8-bit R-2R digital-to-analog converter (DAC) based circuit. The detailed circuit of the 8-bit R-2R DAC based circuit will be described below with respect to FIG. 8. An inverting input of the second amplifier 402 is connected to a common node (VOA1) of the first resistor R1 and the second resistor R2. The third resistor R3 is connected between the inverting input and an output of the second amplifier 402. A non-inverting input of the second amplifier 402 is connected to the predetermined reference VCM.

In some embodiments, VCM serves as a common-mode signal on which all signal operations (addition, subtraction, etc.) are performed. The voltage of VCM can range between 1V and 2V, with VCC/2 often used for a symmetrical voltage swing. VCC is a bias voltage. For a 3.3V bias voltage, a typical value of VCM is 1.5V.

In some embodiments, the resistance value of R2 is equal to the resistance value of R3. The resistance of R2 can be adjusted based on the number of phases controlled by the multiphase controller. For instance, when the multiphase controller operates in a single-phase mode, the resistance of R2 may be 8 kiloohms. When the multiphase controller operates in a 16-phase mode, the resistance of R2 would be 16×8 kiloohms.

As shown in FIG. 4, the integrator time constant control unit 316 comprises a fourth resistor R4, a capacitor C1 and a third amplifier 403. The fourth resistor R4 is connected between the output of the second amplifier 402 and an inverting input of the third amplifier 403. As indicated by the arrow placed on the symbol of R4, the fourth resistor R4 is an adjustable resistor configured to adjust a time constant of the integrator time constant control unit 316. The capacitor C1 is connected between the inverting input and an output of the third amplifier 403. A non-inverting input of the third amplifier is connected to the predetermined reference VCM.

R4 and C1 set the time constant for the integrator time constant control unit 316. This can be adjusted according to the switching frequency of the power converter. In a typical design, a value of 10 pF for C1 and 1 megaohms for R4 would result in a time constant of 10 μs. With a resistance of 100 kiloohms, the time constant would be 1 μs.

In operation, the output voltage varies as a function of the load current. Fine-tuning of the load line can be achieved by adjusting the target voltage in response to changes in load current. To implement this adaptive control, the load current is used to modulate the target voltage, allowing for real-time adjustments based on demand. In some embodiments, an 8-bit R-2R DAC circuit is used to adjust the resistance value of R1. By adjusting the digital input to the DAC, the resistance value of R1 changes accordingly, thereby controlling the target voltage according to varying load conditions.

In operation, the time constant of the control loop is essential to improve response speed and stability, especially when dealing with dynamic load conditions. The time constant is determined by the fourth resistor R4 and the capacitor C1. This time constant determines how quickly the system responds to changes in load current and output voltage. In operation, adjusting this time constant can help the system respond promptly to transient events without excessive overshoot or oscillations. In some embodiments, the resistance value of R4 is adjusted to improve control loop performance, where the output voltage can be modulated effectively and follow load variations closely while maintaining stability. In alternative embodiments, the capacitance value of C1 is adjusted to improve control loop performance. Furthermore, both the resistance value of R4 and the capacitance value of C1 are adjusted in a sync manner to optimize the dc load line control. Additionally, the resistance value of R4 and the capacitance value of C1 are adjusted in an alternating manner to optimize the dc load line control.

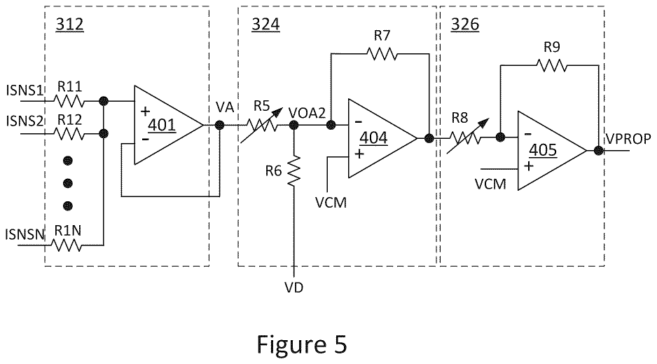

FIG. 5 illustrates a schematic diagram of the ac control path of the load line control apparatus in accordance with various embodiments of the present disclosure. The ac control path comprises the ac load line control unit 324 and the ac gain control unit 326 connected in cascade. The input of the ac control path is configured to receive the average current signal VA generated by the averaging circuit 312 and the droop signal VD generated by the first summing circuit 322. The ac control path is configured to generate an ac load line control signal VPROP.

As shown in FIG. 5, the ac load line control unit 324 comprises a fifth resistor R5, a sixth resistor R6, a seventh resistor R7 and a fourth amplifier 404. The fifth resistor R5 and the sixth resistor R6 are connected in series between the first node and the second node. As shown in FIG. 5, the average current signal VA is tapped at the first node. The droop signal VD is tapped at the second node. As indicated by the arrow placed on the symbol of R5, the fifth resistor R5 is an adjustable resistor controlled by an ac load line control signal. In some embodiments, the fifth resistor R5 is implemented as an 8-bit R-2R DAC based circuit. The detailed circuit of the 8-bit R-2R DAC based circuit will be described below with respect to FIG. 8. An inverting input of the fourth amplifier 404 is connected to a common node (VOA2) of the fifth resistor R5 and the sixth resistor R6. The seventh resistor R7 is connected between the inverting input and an output of the fourth amplifier 404. A non-inverting input of the fourth amplifier 404 is connected to the predetermined reference VCM.

In some embodiments, the resistance value of R6 is equal to the resistance value of R7. The resistance of R6 can be adjusted based on the number of phases controlled by the multiphase controller. For instance, when the multiphase controller operates in a single-phase mode, the resistance of R6 may be 8 kiloohms. When the multiphase controller operates in a 16-phase mode, the resistance of R6 would be 16×8 kiloohms.

As shown in FIG. 5, the ac gain control unit 326 comprises an eighth resistor R8, a ninth resistor R9 and a fifth amplifier 405. The eighth resistor R8 is connected between the output of the fourth amplifier 404 and an inverting input of the fifth amplifier 405. The eighth resistor R8 is an adjustable resistor configured to adjust an ac gain of the ac gain control unit 326. The ninth resistor R9 is connected between the inverting input and an output of the fifth amplifier 405. A non-inverting input of the fifth amplifier 405 is connected to the predetermined reference VCM.

In operation, the output voltage of the power conversion system can be adjusted based on the configuration established in the dc load line control. Using the dc load line as a reference, the ac load line control dynamically modulates the output voltage to accommodate the ac signal variations while staying within the defined load line limits. The 8-bit R-2R DAC circuit is used to adjust the resistance value of R5. By adjusting the digital input to the 8-bit R-2R DAC, the resistance value of R5 changes accordingly, thereby controlling the target voltage according to varying load conditions.

In operation, the resistance value of R8 is adjusted to adjust the ac gain so as to maintain signal quality, optimize performance, and ensure the output signal remains within the intended range.

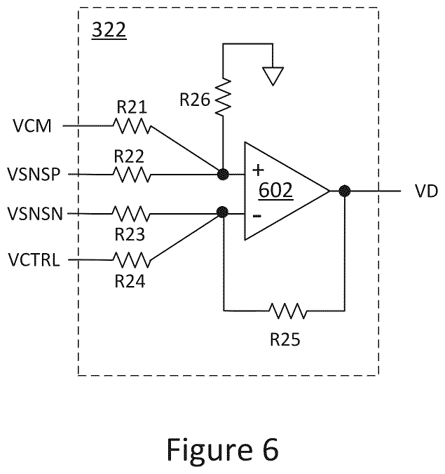

FIG. 6 illustrates a schematic diagram of the first summing circuit shown in FIG. 3 in accordance with various embodiments of the present disclosure. The first summing circuit 322 comprises an amplifier 602 and resistors R21, R22, R23, R24, R25 and R26. The first summing circuit 322 is configured to receive a predetermined reference VCM, a positive output voltage signal VSNSP, a negative output voltage signal VSNSN and a load line control signal VCTRL. The positive output voltage signal VSNSP is tapped from a positive terminal of the power conversion system. The negative output voltage signal VSNSN is tapped from a negative terminal of the power conversion system. The load line control signal VCTRL is used to determine the droop signal VD.

As shown in FIG. 6, the non-inverting input of the amplifier 602 is configured to receive VREF and VSNSP through resistors R21 and R22, respectively. The inverting input of the amplifier 602 is configured to receive VSNSN and VCTRL through resistors R23 and R24, respectively. The resistor R25 is connected between the inverting input and the output of the amplifier 602. The resistor R26 is connected between the non-inverting input of the amplifier 602 and ground. The amplifier 602 is configured to generate the droop signal VD fed into the dc load line control unit 314 and the ac load line control unit 324. In some embodiments, by selecting suitable resistance values of R21-R26, the droop signal VD can be expressed by the following equation:

$$V D = V R E F + ( VSNSP - VSNSN ) - VCTRL \qquad ( 1 )$$

In some embodiments, R21-R26 are 100 kiloohms. It should be noted that the resistance values used herein are selected purely for demonstration purposes and are not intended to limit the various embodiments of the present disclosure to any particular resistance values.

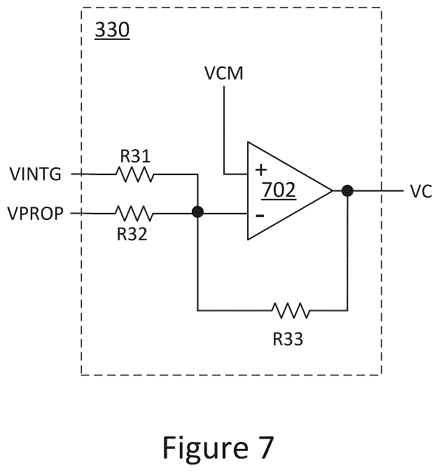

FIG. 7 illustrates a schematic diagram of the second summing circuit shown in FIG. 3 in accordance with various embodiments of the present disclosure. The second summing circuit 330 comprises an amplifier 702 and resistors R31, R32 and R33. The inverting input of the amplifier 702 is configured to receive VINTG through the resistor R31. The inverting input of the amplifier 702 is configured to receive VPROP through the resistor R32. The resistor R33 is connected between the inverting input and the output of the amplifier 702. The non-inverting input of the amplifier 702 is connected to the predetermined reference VCM. In operation, the second summing circuit 330 is configured to receive the output of the integrator time constant control unit 316 and the output of the ac gain control unit 326, and generate a control signal VC.

In some embodiments, R31-R33 are 100 kiloohms. It should be noted that the resistance values used herein are selected purely for demonstration purposes and are not intended to limit the various embodiments of the present disclosure to any particular resistance values.

FIG. 8 illustrates a schematic diagram of the adjustable resistors shown in FIGS. 4-5 in accordance with various embodiments of the present disclosure. Referring back to FIG. 4, the first resistor R1 is implemented as an adjustable resistor. Referring back to FIG. 5, the fifth resistor R5 is implemented as an adjustable resistor. The adjustable resistors are implemented as an N-bit R-2R DAC based circuit. The N-bit R-2R DAC based circuit is configured to convert an N-bit digital signal (B₁, . . . , B_{N-1} and B_{N}) into an analog voltage. As shown in FIG. 8, it uses a resistor ladder network of two resistor values: R and 2R, arranged in a repeating sequence. The N-bit R-2R DAC circuit can be adapted to create an adjustable resistor, where the effective output resistance is controlled by an N-bit digital signal. This is achievable by configuring the R-2R network to vary its resistance based on the digital input, which would effectively allow it to act as a digitally controlled variable resistor.

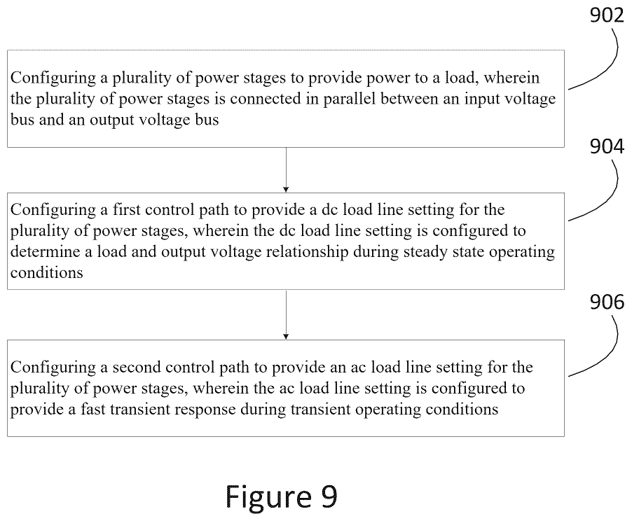

FIG. 9 illustrates a flow chart of a method for load line control in the power conversion system shown in FIG. 1 in accordance with various embodiments of the present disclosure. This flowchart shown in FIG. 9 is merely an example, which should not unduly limit the scope of the claims. One of ordinary skill in the art would recognize many variations, alternatives, and modifications. For example, various steps illustrated in FIG. 9 may be added, removed, replaced, rearranged and repeated.

At step 902, a plurality of power stages is configured to provide power to a load, wherein the plurality of power stages is connected in parallel between an input voltage bus and an output voltage bus.

At step 904, a first control path is configured to provide a dc load line setting for the plurality of power stages, wherein the dc load line setting is configured to determine a load and output voltage relationship during steady state operating conditions.

At step 906, a second control path is configured to provide an ac load line setting for the plurality of power stages, wherein the ac load line setting is configured to provide a fast transient response during transient operating conditions.

In some embodiments, the first control path comprises a dc load line control unit and an integrator time constant control unit connected in cascade between an averaging circuit and a first input of a second summing circuit, and the second control path comprises an ac load line control unit and an ac gain control unit connected in cascade between a first summing circuit and a second input of the second summing circuit, and wherein the averaging circuit comprises a first amplifier configured to receive a plurality of current sense signals and generate an average current signal fed into the dc load line control unit and the ac load line control unit, and the first summing circuit is configured to receive a reference signal, a positive output voltage signal, a negative output voltage signal and a load line control signal, and generate a droop signal fed into the dc load line control unit and the ac load line control unit.

In some embodiments, the dc load line control unit comprises a first resistor, a second resistor, a third resistor and a second amplifier, and wherein the first resistor and the second resistor are connected in series between a first node and a second node, and wherein the average current signal is tapped at the first node, and the droop signal is tapped at the second node, and wherein the first resistor is an adjustable resistor controlled by a dc load line control signal, an inverting input of the second amplifier is connected to a common node of the first resistor and the second resistor, the third resistor is connected between the inverting input and an output of the second amplifier, and a non-inverting input of the second amplifier is connected to a reference, and the integrator time constant control unit comprises a fourth resistor, a capacitor and a third amplifier, and wherein the fourth resistor is connected between the output of the second amplifier and an inverting input of the third amplifier, and wherein the fourth resistor is an adjustable resistor configured to adjust a time constant of the integrator time constant control unit, the capacitor is connected between the inverting input and an output of the third amplifier, and a non-inverting input of the third amplifier is connected to the reference.

In some embodiments, the ac load line control unit comprises a fifth resistor, a sixth resistor, a seventh resistor and a fourth amplifier, and wherein the fifth resistor and the sixth resistor are connected in series between a first node and a second node, and wherein the average current signal is tapped at the first node, and the droop signal is tapped at the second node, and wherein the fifth resistor is an adjustable resistor controlled by an ac load line control signal, an inverting input of the fourth amplifier is connected to a common node of the fifth resistor and the sixth resistor, the seventh resistor is connected between the inverting input and an output of the fourth amplifier, and a non-inverting input of the fourth amplifier is connected to a reference, and the ac gain control unit comprises an eighth resistor, a ninth resistor and a fifth amplifier, and wherein the eighth resistor is connected between the output of the fourth amplifier and an inverting input of the fifth amplifier, and wherein the eighth resistor is an adjustable resistor configured to adjust an ac gain of the ac gain control unit, the ninth resistor is connected between the inverting input and an output of the fifth amplifier, and a non-inverting input of the fifth amplifier is connected to the reference.

The method further comprises configuring a comparator to compare the first current sense voltage signal with a current limit reference, wherein the current limit reference is tapped at a common node of an adjustable current source and a current limit resistor, and dynamically adjusting the adjustable current source to adjust the current limit reference.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

What is claimed is:

1. An apparatus comprising:
a first control path configured to provide a dc load line setting; and
a second control path configured to provide an ac load line setting, wherein:
the dc load line setting is configured to determine a load and output voltage relationship during steady state operating conditions;
the ac load line setting is configured to provide a fast transient response during transient operating conditions; and
the first control path is independent from the second control path.

2. The apparatus of claim 1, wherein:
the first control path is a dc load line control path, and the first control path is a slow control path; and
the second control path is an ac load line control path, and wherein the second control path is fast control path.

3. The apparatus of claim 1, wherein:
the first control path comprises a dc load line control unit and an integrator time constant control unit connected in cascade; and
the second control path comprises an ac load line control unit and an ac gain control unit connected in cascade.

4. The apparatus of claim 3, further comprising:
an averaging circuit comprising a first amplifier configured to receive a plurality of current sense signals and generate an average current signal fed into the dc load line control unit and the ac load line control unit; and
a first summing circuit configured to receive a reference signal, a positive output voltage signal, a negative output voltage signal and a load line control signal, and generate a droop signal fed into the dc load line control unit and the ac load line control unit.

5. The apparatus of claim 3, further comprising:
a second summing circuit configured to receive an output of the integrator time constant control unit and an output of the ac gain control unit, and generate a control signal;
a PWM comparator configured to receive the control signal, a predetermined reference signal and a ramp signal, and generate a PWM signal; and
a phase control logic unit configured to receive the PWM signal, and generate a plurality of gate drive signals for a plurality of power stages of a multiphase power conversion system.

6. The apparatus of claim 3, wherein:
the dc load line control unit comprises a first resistor, a second resistor, a third resistor and a second amplifier, and wherein:
the first resistor and the second resistor are connected in series between a first node and a second node, where an average current signal is tapped at the first node, and a droop signal is tapped at the second node;
an inverting input of the second amplifier is connected to a common node of the first resistor and the second resistor;
the third resistor is connected between the inverting input and an output of the second amplifier; and
a non-inverting input of the second amplifier is connected to a reference.

7. The apparatus of claim 6, wherein:
the first resistor is an adjustable resistor controlled by a dc load line control signal.

8. The apparatus of claim 6, wherein:
the integrator time constant control unit comprises a fourth resistor, a capacitor and a third amplifier, and wherein:
the fourth resistor is connected between the output of the second amplifier and an inverting input of the third amplifier;
the capacitor is connected between the inverting input and an output of the third amplifier; and
a non-inverting input of the third amplifier is connected to the reference.

9. The apparatus of claim 8, wherein:
the fourth resistor is an adjustable resistor configured to adjust a time constant of the integrator time constant control unit.

10. The apparatus of claim 3, wherein:
the ac load line control unit comprises a fifth resistor, a sixth resistor, a seventh resistor and a fourth amplifier, and wherein:
the fifth resistor and the sixth resistor are connected in series between a first node and a second node, where an average current signal is tapped at the first node, and a droop signal is tapped at the second node;
an inverting input of the fourth amplifier is connected to a common node of the fifth resistor and the sixth resistor;
the seventh resistor is connected between the inverting input and an output of the fourth amplifier; and
a non-inverting input of the fourth amplifier is connected to a reference.

11. The apparatus of claim 10, wherein:
the fifth resistor is an adjustable resistor controlled by an ac load line control signal.

12. The apparatus of claim 10, wherein:
the ac gain control unit comprises an eighth resistor, a ninth resistor and a fifth amplifier, and wherein:
the eighth resistor is connected between the output of the fourth amplifier and an inverting input of the fifth amplifier;
the ninth resistor is connected between the inverting input and an output of the fifth amplifier; and
a non-inverting input of the fifth amplifier is connected to the reference.

13. The apparatus of claim 12, wherein:
the eighth resistor is an adjustable resistor configured to adjust an ac gain of the ac gain control unit.

14. A method comprising:
configuring a plurality of power stages to provide power to a load, wherein the plurality of power stages is connected in parallel between an input voltage bus and an output voltage bus;
configuring a first control path to provide a dc load line setting for the plurality of power stages, wherein the dc load line setting is configured to determine a load and output voltage relationship during steady state operating conditions; and
configuring a second control path to provide an ac load line setting for the plurality of power stages, wherein the ac load line setting is configured to provide a fast transient response during transient operating conditions.

15. The method of claim 14, wherein:
the first control path comprises a dc load line control unit and an integrator time constant control unit connected in cascade between an averaging circuit and a first input of a second summing circuit; and
the second control path comprises an ac load line control unit and an ac gain control unit connected in cascade between a first summing circuit and a second input of the second summing circuit, and wherein:
the averaging circuit comprises a first amplifier configured to receive a plurality of current sense signals and generate an average current signal fed into the dc load line control unit and the ac load line control unit; and
the first summing circuit is configured to receive a reference signal, a positive output voltage signal, a negative output voltage signal and a load line control signal, and generate a droop signal fed into the dc load line control unit and the ac load line control unit.

16. The method of claim 15, wherein:
the dc load line control unit comprises a first resistor, a second resistor, a third resistor and a second amplifier, and wherein:
the first resistor and the second resistor are connected in series between a first node and a second node, and wherein the average current signal is tapped at the first node, and the droop signal is tapped at the second node, and wherein the first resistor is an adjustable resistor controlled by a dc load line control signal;
an inverting input of the second amplifier is connected to a common node of the first resistor and the second resistor;
the third resistor is connected between the inverting input and an output of the second amplifier; and
a non-inverting input of the second amplifier is connected to a reference; and
the integrator time constant control unit comprises a fourth resistor, a capacitor and a third amplifier, and wherein:
the fourth resistor is connected between the output of the second amplifier and an inverting input of the third amplifier, and wherein the fourth resistor is an adjustable resistor configured to adjust a time constant of the integrator time constant control unit;
the capacitor is connected between the inverting input and an output of the third amplifier; and
a non-inverting input of the third amplifier is connected to the reference.

17. The method of claim 15, wherein:
the ac load line control unit comprises a fifth resistor, a sixth resistor, a seventh resistor and a fourth amplifier, and wherein:
the fifth resistor and the sixth resistor are connected in series between a first node and a second node, and wherein the average current signal is tapped at the first node, and the droop signal is tapped at the second node, and wherein the fifth resistor is an adjustable resistor controlled by an ac load line control signal;
an inverting input of the fourth amplifier is connected to a common node of the fifth resistor and the sixth resistor;
the seventh resistor is connected between the inverting input and an output of the fourth amplifier; and
a non-inverting input of the fourth amplifier is connected to a reference; and
the ac gain control unit comprises an eighth resistor, a ninth resistor and a fifth amplifier, and wherein:
the eighth resistor is connected between the output of the fourth amplifier and an inverting input of the fifth amplifier, and wherein the eighth resistor is an adjustable resistor configured to adjust an ac gain of the ac gain control unit;
the ninth resistor is connected between the inverting input and an output of the fifth amplifier; and
a non-inverting input of the fifth amplifier is connected to the reference.

18. A power conversion system comprising:
a plurality of power stages connected in parallel between an input voltage bus and an output voltage bus; and
a controller comprising a first control path configured to provide a dc load line setting and a second control path configured to provide an ac load line setting, wherein:
the dc load line setting is configured to determine a load and output voltage relationship during steady state operating conditions;
the ac load line setting is configured to provide a fast transient response during transient operating conditions; and
the first control path is independent from the second control path.

19. The power conversion system of claim 18, further comprising:
an averaging circuit comprising a first amplifier;
a first summing circuit;
a second summing circuit configured to receive an output of an integrator time constant control unit and an output of an ac gain control unit, and generate a control signal;
a PWM comparator configured to receive the control signal, a predetermined reference signal and a ramp signal, and generate a PWM signal; and
a phase control logic unit configured to receive the PWM signal, and generate a plurality of gate drive signals for the plurality of power stages, wherein:
the first control path comprises a dc load line control unit and the integrator time constant control unit connected in cascade; and
the second control path comprises an ac load line control unit and the ac gain control unit connected in cascade, and wherein:
the averaging circuit is configured to receive a plurality of current sense signals and generate an average current signal fed into the dc load line control unit and the ac load line control unit; and
the first summing circuit is configured to receive a reference signal, a positive output voltage signal, a negative output voltage signal and a load line control signal, and generate a droop signal fed into the dc load line control unit and the ac load line control unit.

20. The power conversion system of claim 19, wherein:
the dc load line control unit comprises a first resistor, a second resistor, a third resistor and a second amplifier, and wherein:
the first resistor and the second resistor are connected in series between a first node and a second node, and wherein the average current signal is tapped at the first node, and the droop signal is tapped at the second node, and wherein the first resistor is an adjustable resistor controlled by a dc load line control signal;
an inverting input of the second amplifier is connected to a common node of the first resistor and the second resistor;
the third resistor is connected between the inverting input and an output of the second amplifier; and
a non-inverting input of the second amplifier is connected to a reference;
the integrator time constant control unit comprises a fourth resistor, a capacitor and a third amplifier, and wherein:
the fourth resistor is connected between the output of the second amplifier and an inverting input of the third amplifier, and wherein the fourth resistor is an adjustable resistor configured to adjust a time constant of the integrator time constant control unit;
the capacitor is connected between the inverting input and an output of the third amplifier; and
a non-inverting input of the third amplifier is connected to the reference;
the ac load line control unit comprises a fifth resistor, a sixth resistor, a seventh resistor and a fourth amplifier, and wherein:
the fifth resistor and the sixth resistor are connected in series between the first node and the second node, and wherein the fifth resistor is an adjustable resistor controlled by an ac load line control signal;
an inverting input of the fourth amplifier is connected to a common node of the fifth resistor and the sixth resistor;
the seventh resistor is connected between the inverting input and an output of the fourth amplifier; and
a non-inverting input of the fourth amplifier is connected to the reference; and
the ac gain control unit comprises an eighth resistor, a ninth resistor and a fifth amplifier, and wherein:
the eighth resistor is connected between the output of the fourth amplifier and an inverting input of the fifth amplifier, and wherein the eighth resistor is an adjustable resistor configured to adjust an ac gain of the ac gain control unit;
the ninth resistor is connected between the inverting input and an output of the fifth amplifier; and
a non-inverting input of the fifth amplifier is connected to the reference.
